(19) United States
(12) Patent Application Publication
(10) Pub. No.: US 2004/0152033 A1
(43) Pub. Date: Aug. 5, 2004

(54) Orthodontic appliance

(76) Inventor: John A. Collins JR., Lakeville, IN (US)

Correspondence Address: Ryan M. Fountain, Esq., 420 Lincoln Way West, Mishawaka, IN, 46544, US

(21) Appl. No.: 10/355,690

(22) Filed: Feb. 3, 2003

(51) Int. Cl. A61C 3/00

(52) U.S. Cl. 433/7

(57) ABSTRACT

A rapid palatal expansion device is provided having first and second housing parts joined by a threaded spindle which controls the relative position of those housing parts, the spindle incorporating a ratchet/stop system to prevent unwanted screw slippage or backwinding while exerting expansion force to the appliance. Each housing part includes at least one extending rod for transmitting the expansion force to the patient's teeth or body parts. The housing parts may be oriented with respect to each other by a pair of guide rods extending through them. Directional indicia may be formed on one or more of the housing parts to facilitate spindle adjustment by the orthodontist.

### BACKGROUND AND SUMMARY OF THE INVENTION

The present invention relates generally to orthopedic devices and, more particularly, to rapid orthodontic/orthopedic palatal expansion or spreader appliances for dental arches.

Various orthodontic and orthopedic devices are known to apply force to the teeth, jaw or related body parts. In general, one such type of appliance is referred to as an orthopedic expander which is mounted within a patient's mouth to expand the palate. Various prior patents, such as U.S. Pat. Nos. 3,835,540, 4,347,054, 4,482,318 and 5,281,133, show these devices, the latter showing at attempt at a rapid palatal expansion (RPE) device.

Many of these prior devices, and RPEs in particular, include a threaded spindle for controllably separating two housing parts, each housing part having one or more force transmitting rods extending toward the teeth. Unfortunately, it is often the case with these prior devices that the threaded spindle is subject to slippage or backwinding (such as lengendary screw backwinding) once set in place for use, in part due, for example, to the countervailing forces exerted on it by the teeth, the high flex applied to the device from the patient's chewing of food, and/or from the high variations in sizing and fitting the devices into the patient's mouth (i.e., the tolerance changing from the bending to fit, etc.).

Various attempts have been made to compensate for or reduce this slippage. Double threading of the spindle has been suggested, but that can significantly increase the spindle cost if done so within the manufacturing tolerances needed due to the small size constraints of dental and orthodontic components. Teflon coatings have been suggested, but due to the heat applied in the forming process, tolerances can be reduced and unpredictable results obtained, sometimes requiring removal and replacement of the appliance. In general, since these appliances are used within a patient's mouth for relatively long periods of time, dimensional constraints and durability are severe. Moreover, the mechanisms for activation and adjustment must be readily accessible to the orthodontist.

Accordingly, it is an object of the present invention to provide an improved orthodontic appliance, especially one which:

1. More reliably transmits desired force to the body parts for sustained periods of time in use,

2. Is less prone to slippage and backwinding,

3. Is relatively inexpensive to manufacture,

4. Can be readily adjusted once mounted in place, and

5. Can accommodate a variety of different applications and housing modifications.

These and other objects of the present invention are attained by the provision of a rapid palatal expansion device having first and second housing parts joined by a threaded spindle which controls the relative position of those housing parts, the spindle incorporating a ratchet/stop system to prevent unwanted screw slippage or backwinding while exerting expansion force to the appliance. Each housing part includes at least one extending rod for transmitting the expansion force to the patient's teeth or body parts. The housing parts may be oriented with respect to each other by a pair of guide rods extending through them. Directional indicia may be formed on one or more of the housing parts to facilitate spindle adjustment by the orthodontist.

Other objects, advantages and novel features of the present invention will now become readily apparent to those of skill in this art from the following drawings and detailed description.

### BRIEF DESCRIPTION OF THE DRAWINGS

FIG. 1 shows a top view of a RPE incorporating the present invention in the fully closed position.

FIG. 2 shows a bottom view of the RPE of FIG. 1.

FIG. 3 shows a top schematic view of the RPE of FIG. 1, illustrating internal components.

FIG. 4 shows the view of FIG. 3 with the RPE in an opened position.

FIG. 5 shows an enlarged view of the threaded spindle of the RPE of FIG. 1.

FIG. 6 shows a cross-sectional view through line 6-6 of FIG. 5.

FIG. 7 shows an left end view of the threaded spindle of FIG. 5.

FIGS. 8a-8e show an enlarged left end view of the left housing part of the RPE of FIG. 1 at various consecutive positions of the threaded spindle.

### DETAILED DESCRIPTION OF PREFERRED EMBODIMENTS

The present invention is illustrated in the drawings as incorporated within an RPE appliance. Such appliances can be used in a variety of implementations, such as rapid maxillary expansion, distalization, upper or lower palatal expansion, space closure, etc. at the instance of the attending orthodontist or surgeon.

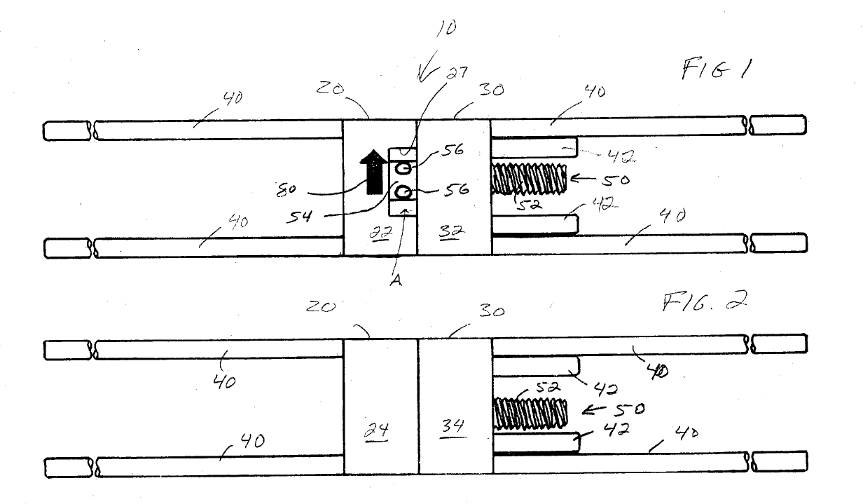

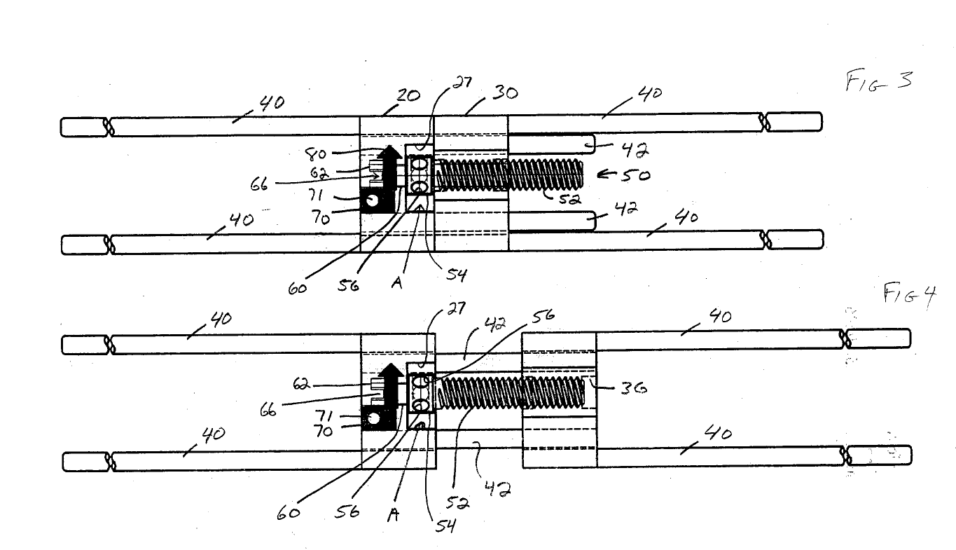

As shown in FIG. 1, the RPE 10 includes left housing part 20 and right housing part 30. Each such housing part is, for example, formed from a top and bottom portion which is welded, clamped, brazed or otherwise joined together in a conventional manner. Thus, left housing part 20 includes top portion 22 and bottom portion 24, and right housing part 30 likewise includes top portion 32 and bottom portion 34. The formation of the housing parts in this manner is suggested for manufacturing efficiency rather than as a requirement of the present invention. The structure of the housing parts used in the present invention could alternatively be formed by other means, such as machining of solid parts, but likely at a greater cost.

Left housing part 20 includes an internal passageway 26, preferably formed with an enlarged region 27 connecting to a constricted region 28. Another enlarged region 29 is preferably connected to constricted region 28 opposite the connection to enlarged region 27. In certain embodiments, passageway 26 can extend completely through left housing part 20, but it is not necessary that it do so in all applications. It is advantageous to form left housing part 20 with a portion A of enlarged region 27 exposed for external access to the passageway. This can be done, for example, by forming a notch or cut-out area on top portion 22 that is not present on bottom portion 24.

Right housing part 30 includes an internal passageway 36 that is preferably threaded along at least a portion of its length. If passageway 36 is not threaded along its entire length, the unthreaded portion is preferably formed of greater dimension than the threaded portion so as not to constrain threading movement of an object through the threaded portion.

Each housing part is formed to receive at least one extending rod 40. These rods are preferably fixed to their respective housing parts and are used to transmit force from the housing parts to the teeth or body areas in a conventional manner. That force will typically be used to expand the teeth or body areas, such as the palate. In especially preferred embodiments, housing parts 20 and 30 can be maintained in a desired orientation with respect to each other through the use of one or more guide rods 42. These guide rods are, for example, each fixed at one end or portion thereof to one of the housing parts and slidably received by the other housing part. Use of two or more guide rods can serve to prevent twisting motion of the housing parts with respect to each other if the guide rods are formed of conventional cylindrical rods. In other embodiments, that same result may be achieved by a single guild rod if the rod is configured differently, such as to have a rectangular cross section rather than circular. The guide rods may be fixed to either housing part as desired in a given application. As shown in the drawings, both guide rods 42 are fixed to housing part 20 and slidably received within housing part 30.

By way of example, housing parts 20 and 30 as shown in the drawings are approximately 11 mm wide (width being measured in the direction across rods 40) and approximately 6 mm in length (length being measured along the length of rods 40). Housing parts 20 and 30 and rods 40 and 42 may, for example, be formed from conventional materials used in orthodontic appliances.

Housing parts 20 and 30 are joined by a threaded spindle 50 which controls the relative position of those housing parts. Spindle 50 is movably mounted within both passageway 26 and passageway 36, preferably for rotational movement within passageway 26 and rotational and longitudinal movement (via threading) withing passageway 36. Spindle 50 includes a threaded portion 52 which is formed to be matingly received within passageway 36 by the threads in that passageway. Rotation of threaded portion 52 within passageway 36 serves to apply expansion or contraction force to housing part 30, moving it away from or toward housing part 20 according to the direction of rotation of spindle 50.

Spindle 50 also includes sprocket portion 54 which is formed so as to be rotatably received with width-wise clearance within enlarged region 27. Sprocket portion 54 includes, for example, a plurality of recesses 56 therein. As shown in FIG. 6, these recesses can be formed by two intersecting passageways 58 passing laterally through spindle 50 to create four recesses 56. Any other number of recesses can be used as desired for a given application or embodiment. Recesses 56 are dimensionally formed so as to received a tool for insertion therein to turn spindle 50. In the embodiment shown in the drawings, that tool can be a cylindrical rod of conventional nature. Enlarged region 27 and exposed area A are formed so as to allow such rods to have sufficient access to recesses 56 for insertion and a measure of turning (width-wise relative to housing part 20) that exposes the next adjacent recess of sprocket portion 54 for similar insertion and turning. In alternative embodiments, sprocket 54 may alternatively be formed with projections, rather than recesses 56, which can be engaged to rotate spindle 50.

Spindle 50 further includes neck portion 60 which is closely and rotatably received within constricted region 28. Spindle 50 also includes ratchet portion 62 which is rotatably received within enlarged portion 28. Ratchet portion 62 is, for example, of greater cross sectional dimension than neck portion 60 such that constricted region 60 serves to retain spindle 50 within left housing part 20 while permitting its rotational motion.

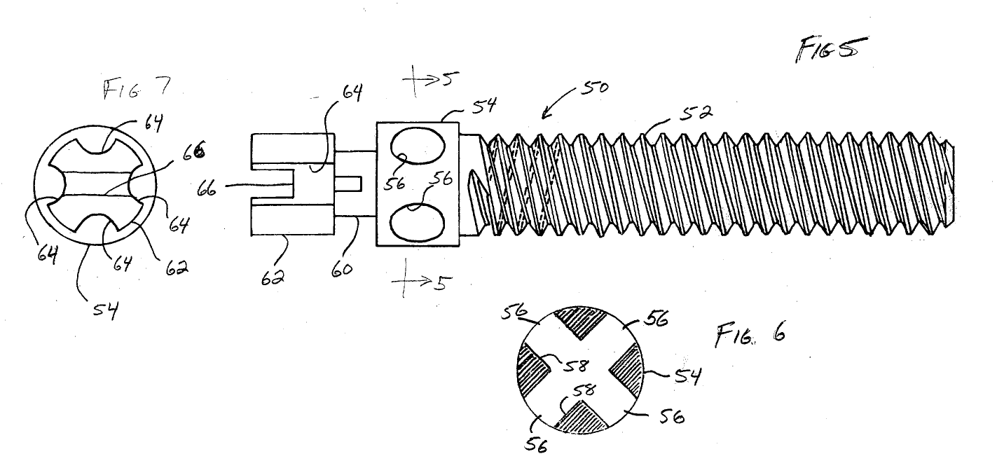

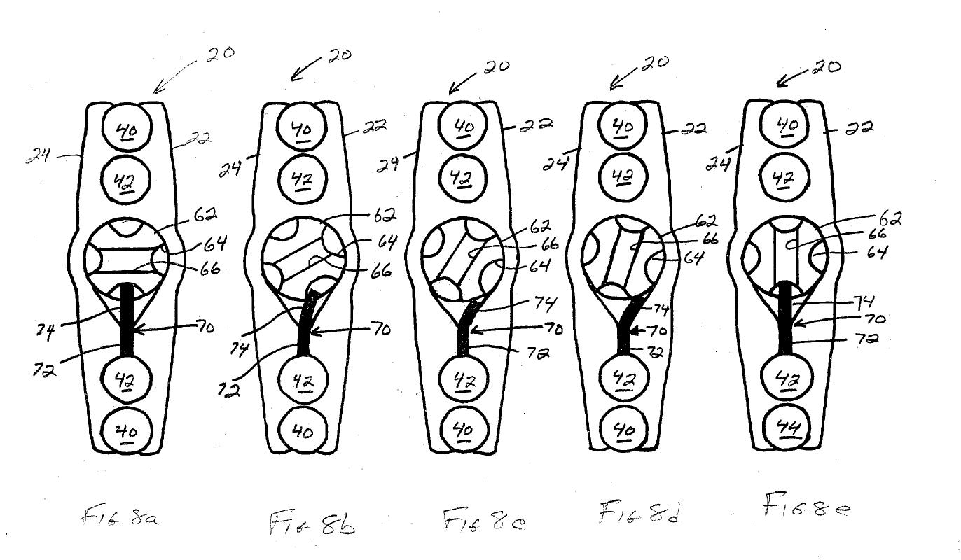

Ratchet portion 62 is, for example, formed with a plurality of indentations or notches 64 about its circumference. An actuation slot 66 may also be formed across the end face of ratchet portion 62. The number of notches shown in FIGS. 7 and 8 are four, but that is by way of example only. Any number of notches can be employed as desired in a given application or embodiment, according to the degree of spindle slip rotation permissible and the dimensional constraints of a given appliance.

Left housing part 20 includes a stop member 70, mounted at enlarged region 29. Stop member 70 is, for example, clamped at one end 72 between top portion 22 and bottom portion 24. Stop member 70 is, for example, secured to left housing part 20 by a locating pin 71, welded or brazed though an opening in the housing. A free end 74 of stop member 70 extends into enlarged portion 29 and is, for example, placed to abut ratchet portion 62.

In the example shown in FIGS. 8a-8e, free end 74 extends into notches 64 as spindle 50 is rotated within left housing part 20. Stop member 70 is preferably formed from a durable and resilient metal material, such as a titanium alloy (nickle or copper titanium alloys of a type used for memory wire will often suffice). Stop member 70 bends within enlarged region 29 as spindle 50 is rotated between notches, as seen in FIGS. 8b-8d. Stop member 70 extends back to its straight length when spindle 50 is rotated such that it aligns with and into a notch 64, as seen in FIGS. 8a and 8e. When stop member 70 aligns with and into a notch 64, it resists bending. Thus, stop member 70 serves to restrict rotation of spindle 50 that would remove it from that notch.

Accordingly, stop member 70 acts with spindle 50 to restrict undesired motion of spindle 50, such as would otherwise be caused by slippage or backwinding once RPE 10 is mounted within the patient. The application of intended rotational force through recesses 56 of sprocket portion 54 can readily overcome the bending resistance of stop member 70. However, unintended rotation is of sufficiently less force that the stop member remains unbent. In order to facilitate utilization of RPE 10, an arrow indicia 80 is, for example, formed on top portion 22 which informs the orthodontist or installer of RPE 10 of the direction of rotation of spindle 50 needed for expansion of the RPE (movement of right housing part 30 away from left housing part 20).

In especially preferred embodiments, notches 64 are formed symetricly, that is, with the same degree of slope (or other applicable dimensional change) on each side of the notch so that the resistance of stop member 70 to bending is the same regardless of the direction of rotation of spindle 50. Thus, the ratchet/stop arrangement would work in either direction of rotation. By encapsulating spindle 50 and stop member 70 in the manner of the present invention, operation of the features thereof does not detrimentally impact the patient in any significant manner, as for example, by interfering with eating or cleaning of the appliance.

In the embodiment shown in the drawings, enlarged region 29 is open at one end so as to allow access to actuation slot 66 for more rapid rotation of spindle 50 during initial application or final removal of the appliance if that is desired by the orthodontist or installer. Also, the nature of the threading used by spindle 50 can be altered as needed. For example, threaded portion 52 can be formed with a spiral threading or multiple threading to further increase the threading friction and reduce the amount of slippage and back threading or backwinding and/or to increase the installation efficiency in making the initial setting of the appliance. Also, the present invention has been illustrated in a RPE appliance, but can be readily adapted to other orthodontic and orthopedic devices as needed in both temporary and permanent applications.

Therefore, although the present invention has been illustrated and describe above in specific embodiments, those are by way of illustration and example only and are not to be taken as a limitation to the scope of the invention. The spirit and scope of the present invention are limited only by the terms of the claims below.

What is claimed is:

1. An orthodontic device comprising:
a first housing part,
a second housing part,
a threaded spindle connected to the first and second housing parts and controlling the relative position of those housing parts to each other, and
an arrangement to restrict unintended rotation of the threaded spindle during use of the orthodontic device.

2. The orthodontic device of claim 1 wherein the arrangement includes and ratchet and stop structure formed between the spindle and at least one of the housing parts.

3. The orthodontic device of claim 1 wherein guide bars are provided between the first and second housing parts so as to maintain a desired orientation between the first and second housing parts.

4. The orthodontic device of claim 3 wherein force transmitting rods are connected to each housing part for transferring expansion or contraction forces to the user's body parts.

5. The orthodontic device of claim 4 wherein indicia is formed on at least one of the housing parts to indicate of the direction rotation of the spindle that will result in further separation of the first and second housing parts.

6. A medical device for applying force to body parts of a user, comprising:
a first housing part,
a second housing part,
a threaded spindle mounted for rotation within the first housing part and mounted for threaded movement within the second housing part,
at least one guide rod fixed to one of the housing parts and slidably received by the other housing part,
the spindle including a sprocket portion accessible through the first housing part for applying rotational force to the spindle,
the spindle including a ratchet portion, and
a stop member mounted to the first housing part for engagement with the ratchet portion to restict rotation of the spindle.
